(19) United States
(12) Patent Application Publication
(10) Pub. No.: US 2026/0122060 A1
(43) Pub. Date: Apr. 30, 2026

(54) METHOD, SYSTEM AND APPARATUS FOR REDUCING SERVER NOISE, DEVICE, AND COMPUTER NONVOLATILE READABLE STORAGE MEDIUM

(71) Applicant: SUZHOU METABRAIN INTELLIGENT TECHNOLOGY CO., LTD., Suzhou, Jiangsu (CN)

(72) Inventors: Yunxia LIU, Suzhou, Jiangsu (CN); Jianjun CHENG, Suzhou, Jiangsu (CN); Mingyuan LU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/470,318

(22) PCT Filed: Sep. 29, 2024
(86) PCT No.: PCT/CN2024/122519

§ 371 Date: Sep. 29, 2025

(30) Foreign Application Priority Data
Jan. 17, 2024 (CN) 202410065333.6

(51) Int. Cl. G05B 13/02; H04L 9/40

(52) U.S. Cl. CPC G05B 13/0205; H04L 63/083

(57) ABSTRACT

A method and a system for reducing server noise, a device, and a computer nonvolatile readable storage medium are provided. Server type information of the server is determined. The server type information is sent to a noise reduction device, and the noise reduction device performs noise reduction on the server according to an environmental noise cancellation method when the server type information is voice server, or the noise reduction device performs noise reduction on the server according to an active noise control method when the server type information is non-voice server. The noise reduction device is connected with the server in a hot plug manner.

### CROSS-REFERENCE TO RELATED APPLICATIONS

The present disclosure is a National Stage Entry under 35 U.S.C. § 371 of PCT International Application No. PCT/CN2024/122519, filed on Sep. 29, 2024, which claims the priority to Chinese Patent Application No. 202410065333.6, filed with the Chinese Patent Office on Jan. 17, 2024 and entitled “Method, System and an Apparatus for Reducing Server Noise, Device, and Computer nonvolatile readable Storage Medium”, the entire contents of each of which are incorporated herein by reference for all purposes.

### TECHNICAL FIELD

Examples of the present disclosure relate to the field of computers, and particularly relates to a method, a system for reducing server noise, a device, and a computer nonvolatile readable storage medium.

### BACKGROUND

With the advancement of technology, the functions of the server are becoming increasingly diverse and its power consumption is also increasing, the server needs to be capable of supporting more central processing units (CPUs), network cards, memory, graphics processing units (GPUs), etc. As a result, higher demands are being placed on server cooling systems. For air-cooled cooling servers, increasing the number of fans and raising their speed are still ways to deal with cooling issues, but these definitely lead to more environmental noise.

To reduce server noise, methods such as water cooling and larger fan installation are employed to minimize or eliminate noise generation. Alternatively, noise impact is mitigated by establishing separate server rooms, high-noise laboratories, or configuring a set of server-specific silent cabinets. However, such measures of water cooling and larger fan installation marginally reduce fan noise, the effect is not particularly significant, and significantly consume the internal space of the server. Establishing separate server rooms, high-noise laboratories, or configuring a set of server-specific silent cabinets not requires guaranteeing adequate server ventilation but also involves excessive noise reduction costs with poor applicability.

In summary, how to efficiently and accurately reduce the server noise is a pressing issue that those skilled in the art urgently need to address.

### SUMMARY

An objective of the present disclosure is to provide a method for reducing server noise, and the method can solve, to a certain extent, a technical issue of how to perform noise reduction on a server conveniently and accurately. Some embodiments of the present disclosure provide a system and an apparatus for reducing server noise, an electronic device, and a computer nonvolatile readable storage medium.

In order to achieve the above objective, the present disclosure provides the following technical solutions.

A method for reducing server noise is applied to a server. The method includes:
determining server type information of the server; and
sending the server type information to a noise reduction device, and making the noise reduction device perform noise reduction on the server according to an environmental noise cancellation method when the server type information is voice server, or making the noise reduction device perform noise reduction on the server according to an active noise control method when the server type information is non-voice server, where
the noise reduction device is connected with the server in a hot plug manner.

In an illustrative example, the method for reducing server noise also includes:
obtaining an access right of a user;
obtaining device information of the noise reduction device which allows the access right to access; and
sending, through a baseboard management controller of the server, the device information to a network interface of the baseboard management controller, and then viewing, by the user, the device information in the network interface.

In an illustrative example, after the sending, through a baseboard management controller of the server, the device information to a network interface of the baseboard management controller, the method for reducing server noise also includes:
receiving, through the baseboard management controller, a first regulation instruction transmitted by the network interface; and
sending the first regulation instruction to the noise reduction device, to make the noise reduction device perform work control according to the first regulation instruction.

In an illustrative example, before the obtaining an access right of a user, the method for reducing server noise also includes:
obtaining a login request for accessing in to the network interface of the baseboard management controller;
in respond to the login request, and displaying the network interface;
obtaining login information input by the user in the network interface; and
verifying the login information, and performing, in a case of a verification success, the obtaining an access right of a user.

In an illustrative example, the method for reducing server noise also includes:
obtaining an access right of a user;
obtaining device information of the noise reduction device which allows the access right to access; and
sending, through a basic input output system of the server, the device information to a setting interface of the basic input output system, and then viewing, by the user, the device information in the setting interface.

In an illustrative example, after the sending, through a basic input output system of the server, the device information to a setting interface of the basic input output system, the method for reducing server noise also includes:
receiving, through the basic input output system, a second regulation instruction transmitted by the setting interface; and
sending the second regulation instruction to the noise reduction device, to make the noise reduction device perform work control according to the second regulation instruction.

In an illustrative example, the method for reducing server noise also includes:
collecting server performance information of the server; and
sending the server performance information to the noise reduction device, to make the noise reduction device perform noise prediction on the server based on the server performance information.

In an illustrative example, the collecting server performance information of the server includes:
collecting fan speed information of the server;
collecting a quantity value of central processing units of the server and a first temperature value of each central processing unit;
collecting a second temperature value of an internal memory of the server;
collecting a working frequency value of a radiator of the server; and
taking a fan speed information, a quantity value, a first temperature value, a second temperature value, and a working frequency value as the server performance information.

A method for reducing server noise is applied to a noise reduction device. The method includes:
obtaining server type information sent by a server;
performing noise reduction on the server according to an environmental noise cancellation method in a case where the server type information is voice server; and
performing noise reduction on the server according to an active noise control method in a case where the server type information is non-voice server, where
the noise reduction device is connected with the server in a hot plug manner.

In an illustrative example, the method for reducing server noise also includes:
obtaining server performance information sent by the server;
performing data cleaning and selection on the server performance information to obtain target performance information;
sending the target performance information to a prediction model pre-trained based on an extreme gradient boosting (XGBoost) algorithm; and
receiving a noise value of the server output by the prediction model.

In an illustrative example, before the obtaining server performance information sent by the server, wherein the method for reducing serve noise includes:
collecting a known noise value and corresponding known performance information of the server;
training the prediction model by using the known noise value and the known performance information, and calculating a corresponding loss value; and
ending training of the prediction model after a loss value satisfies a set requirement, and otherwise reapplying the known noise value and the known performance information to perform a new round of training on the prediction model.

In an illustrative example, the performing noise reduction on the server according to an active noise control method includes:
processing a noise signal by a three-dimensional open-sound-field active noise control processing unit.

In an illustrative example, the processing a noise signal by a three-dimensional open-sound-field active noise control processing unit includes:
calculating an anti-noise signal for noise reduction by the three-dimensional open-sound-field active noise control processing unit through an indoor three-dimensional sound source positioning optimization algorithm, an adaptive filtering algorithm, a least mean square algorithm and a current noise reduction hardware device; and
outputting the anti-noise signal with fidelity by the three-dimensional open-sound-field active noise control processing unit through a high-fidelity speaker to emit an anti-phase sound wave, where the anti-phase sound wave is a sound wave having a same amplitude but an opposite phase to the noise signal, and the anti-phase sound wave is used for being superimposed with the noise signal.

In an illustrative example, the performing noise reduction on the server according to an environmental noise cancellation method includes:
processing a noise signal by a three-dimensional open-sound-field environmental noise cancellation processing unit.

In an illustrative example, before the processing a noise signal by a three-dimensional open-sound-field environmental noise cancellation processing unit, the method for reducing server noise includes:
correcting a gain of a microphone array and a delay of microphones;
detecting whether data collected by a voice microphone are a voice segment;
estimating environmental noise according to environmental noise collected by a reference microphone and voice data collected by the voice microphone in a case of detecting that the data collected by the voice microphone are a voice segment, calculating a corresponding noise suppression parameter, and filtering environmental noise out by a filter module; and performing no environmental noise filtering in a case of detecting that the data collected by the voice microphone are not a voice segment.

A system for reducing server noise includes a server and a noise reduction device that are connected in a hot plug manner.

The server is configured to determine server type information and send the server type information to the noise reduction device.

The noise reduction device is configured to perform noise reduction on the server according to an environmental noise cancellation method when the server type information is voice server, or perform noise reduction on the server according to an active noise control method when the server type information is non-voice server.

In an illustrative example, the server is provided with a universal serial bus interface supporting hot plug and having uniform standards.

The noise reduction device is provided with a universal serial bus plug matching the universal serial bus interface.

An electronic device includes:
a memory configured to store a computer program; and
a processor configured to implement steps of any one of the above methods for reducing server noise when executing the computer program.

A computer nonvolatile readable storage medium stores a computer program. The computer program implements steps of any one of the above methods for reducing server noise when executed by a processor.

Some embodiments of the present disclosure provides a method for reducing server noise, applied to a server. The server type information of the server is determined. The server type information is sent to the noise reduction device, and the noise reduction device performs noise reduction on the server according to the environmental noise cancellation method when the server type information is voice server, or the noise reduction device performs noise reduction on the server according to the active noise control method when the server type information is non-voice server. The noise reduction device is connected with the server in a hot plug manner. The present disclosure has the following beneficial effects: the server sends the server type information of the server to the noise reduction device, then the noise reduction device performs noise reduction on the server according to the environmental noise cancellation method when the server type information is voice server, or performs noise reduction on the server according to the active noise control method when the server type information is non-voice server. A noise reduction method adapted to the server is flexibly selected for noise reduction, and noise reduction accuracy is desirable. The noise reduction device is connected with the server in a hot plug manner. Thus when noise reduction is required for the server, the noise reduction device needs to be connected with the server. When no noise reduction is required for the server, the noise reduction device is separated from the server, and noise reduction management can be quickly performed on the server. The system for reducing server noise, the electronic device, and the computer nonvolatile readable storage medium provided in the present disclosure also solve corresponding technical problems.

### BRIEF DESCRIPTION OF THE DRAWINGS

In order to more clearly illustrate technical solutions in the examples of the present disclosure or in the prior art, a brief introduction to the accompanying drawings required for the description of the examples or the prior art will be provided below. Apparently, the accompanying drawings in the following description are merely the examples of the present disclosure, and those of ordinary skill in the art would also be able to derive other drawings from these provided drawings without making creative efforts.

FIG. 1 is a first flowchart of a method for reducing server noise according to some embodiments of the present disclosure;

FIG. 2 is a second flowchart of a method for reducing server noise according to some embodiments of the present disclosure;

FIG. 3 is a third flowchart of a method for reducing server noise according to some embodiments of the present disclosure;

FIG. 4 is a fourth flowchart of a method for reducing server noise according to some embodiments of the present disclosure;

FIG. 5 is a fifth flowchart of a method for reducing server noise according to some embodiments of the present disclosure;

FIG. 6 is a schematic structural diagram of a system for reducing server noise according to some embodiments of the present disclosure;

FIG. 7 is a schematic structural diagram of an apparatus for reducing server noise according to some embodiments of the present disclosure;

FIG. 8 is a schematic structural diagram of an electronic device according to some embodiments of the present disclosure; and

FIG. 9 is another schematic structural diagram of an electronic device according to some embodiments of the present disclosure.

### DETAILED DESCRIPTION OF THE EMBODIMENTS

The technical solutions in embodiments of the present disclosure are clearly and completely described below with reference to the accompanying drawings in the embodiments of the present disclosure. Apparently, the embodiments described are merely some embodiments rather than all embodiments of the present disclosure. All other embodiments obtained by those of ordinary skill in the art based on the embodiments of the present disclosure without creative efforts shall fall within the protection scope of the present disclosure.

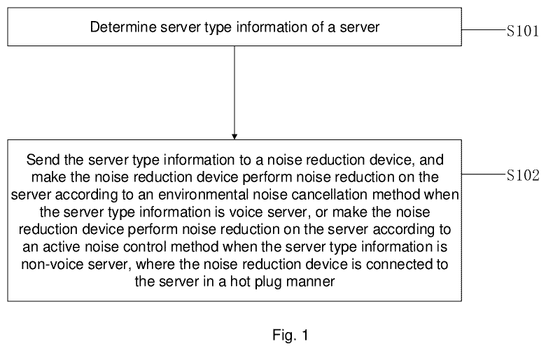

With reference to FIG. 1, FIG. 1 is a first flowchart of a method for reducing server noise according to some embodiments of the present disclosure.

A method for reducing server noise provided in some embodiments of the present disclosure is applied to a server. The method include:

S101: server type information of the server is determined.

In practical application, the server is first determines its own type information, that is, the server type information of the server is determined first. The server type information includes voice server or non-voice server.

S102: the server type information is sent to a noise reduction device, and the noise reduction device performs noise reduction on the server according to an environmental noise cancellation method when the server type information is voice server, or the noise reduction device performs noise reduction on the server according to an active noise control method when the server type information is non-voice server, where the noise reduction device is connected with the server in a hot plug manner.

In practical application, after determining the server type information of the server, the server sends the server type information to the noise reduction device, such that the noise reduction device performs targeted noise reduction on the server according to the server type information.

In practical application, after receiving the server type information, the noise reduction device performs noise reduction on the server according to the environmental noise cancellation (ENC) method when the server type information is voice server, and perform noise reduction on the server according to the active noise control (ANC) method when the server type information is non-voice server.

It should be noted that the noise reduction device in the present disclosure is connected with the server in a hot plug manner, such that the noise reduction device implements plug-and-play. Thus a failed noise reduction device is removed or replaced without influencing normal working of the server. Moreover, hot plug in the present disclosure includes two aspects of power hot plug and signal hot plug. When the noise reduction device is physically connected with the server through an interface, a hardware layer connected with a system controls a transient surge current on a power bus at a low level through a metal oxide semiconductor (MOS) field effect transistor on-off method to implement electrical connection, such that the power hot plug is implemented. A purpose of the signal hot plug is to properly “isolate” a signal line from a control center of the server and terminate all communication before a module is powered off. When no signal hot plug design is added to a power module of the server, a transient voltage is generated on the signal line, and this may lead to abnormal communication of the server. When the signal hot plug design is added, the transient voltage is limited to a reasonable level, and the control center of the server is instructed in advance to terminate a communication task, such that the signal hot plug is implemented.

Some embodiments of the present disclosure provide a method for reducing server noise, applied to a server. The server type information of the server is determined. The server type information is sent to the noise reduction device, and the noise reduction device performs noise reduction on the server according to the environmental noise cancellation method when the server type information is voice server, or the noise reduction device performs noise reduction on the server according to the active noise control method when the server type information is non-voice server. The noise reduction device is connected with the server in a hot plug manner. The present disclosure has the following beneficial effects: the server sends the server type information of the server to the noise reduction device, then the noise reduction device performs noise reduction on the server according to the environmental noise cancellation method when the server type information is voice server, or performs noise reduction on the server according to the active noise control method when the server type information is non-voice server. A noise reduction method adapted to the server is flexibly selected for noise reduction, and noise reduction accuracy is desirable. The noise reduction device is connected with the server in a hot plug manner. Thus when noise reduction is required for the server, the noise reduction device only needs to be connected to the server. When no noise reduction is required for the server, the noise reduction device is separated from the server, and noise reduction management can be quickly performed on the server.

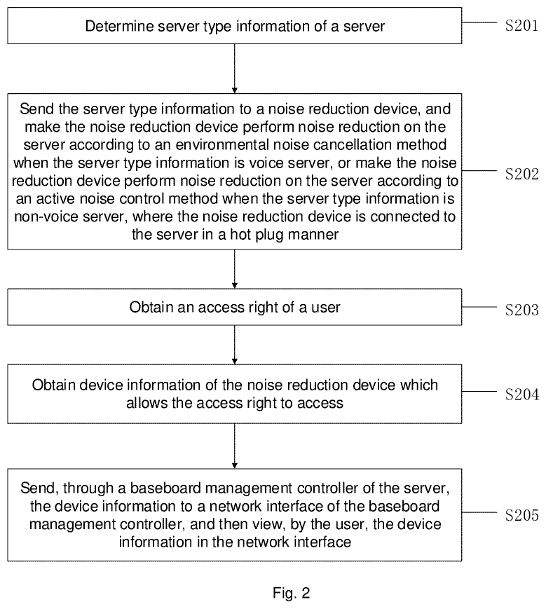

With reference to FIG. 2, FIG. 2 is a second flowchart of a method for reducing server noise according to an example of the present disclosure.

A method for reducing server noise provided in the example of the present disclosure is applied to a server. The method includes:
S201: server type information of the server is determined.
S202: the server type information is sent to a noise reduction device, and the noise reduction device performs noise reduction on the server according to an environmental noise cancellation method when the server type information is voice server, or the noise reduction device performs noise reduction on the server according to an active noise control method when the server type information is non-voice server, where the noise reduction device is connected with the server in a hot plug manner.
S203: an access right of a user is obtained.
S204: device information of the noise reduction device which allows the access right to access is obtained.
S205: the device information is sent through a baseboard management controller of the server to a network interface of the baseboard management controller, and then the user views the device information in the network interface.

In practical application, when the noise reduction device is used to perform noise reduction on the server, in order to make the user understand working information of the noise reduction device through the server conveniently, the access right of the user is obtained. The device information of the noise reduction device which allows the access right to access by is obtained. The device information is sent through the baseboard management controller (BMC) of the server to the network interface of the baseboard management controller, and then the user views the device information in the network interface. The access right determines how much information of the noise reduction device the user can view. For example, a user with a lower access right can only view a name and power consumption of the noise reduction device, and a user with a higher access right can view a working mode and power switch options of the noise reduction device. Moreover, the access right also is used for determining whether the user can operate the noise reduction device, etc., which is not limited herein.

It should be noted that the device information of the noise reduction device is determined according to actual needs. For example, the device information of the noise reduction device includes a noise reduction mode, a plurality of microphone noise collection values, a noise value after noise reduction, etc.

In a practical application scenario, in order to facilitate control over the noise reduction device through the server by the user, the server further receives, through the baseboard management controller, a first regulation instruction transmitted by the network interface after sending the device information to the network interface of the baseboard management controller through the baseboard management controller of the server; and send the first regulation instruction to the noise reduction device, to make the noise reduction device perform work control according to the first regulation instruction. Thus the baseboard management controller of the server is used to control the noise reduction device. A content of the first regulation instruction is flexibly determined according to actual needs. For example, the first regulation instruction includes a mode regulation instruction of the noise reduction device, a power switch regulation instruction, etc.

In a practical application scenario, before obtaining the access right of the user, the server further performs security verification on a process of the user logging in to the network interface, that is, obtains a login request for accessing in to the network interface of the baseboard management controller; in respond to the login request, and displaying the network interface; obtain login information input by the user in the network interface; and verify the login information, and perform, in a case of a verification success, the step that the access right of the user is obtained. It should be noted that when the network interface of the baseboard management controller is on the server, the server control processes such as login of the network interface. When the network interface of the baseboard management controller is on other devices instead of the server, the processes such as login of the network interface can be controlled by the other devices. In this case, the server needs to receive corresponding information of the network interface through the baseboard management controller.

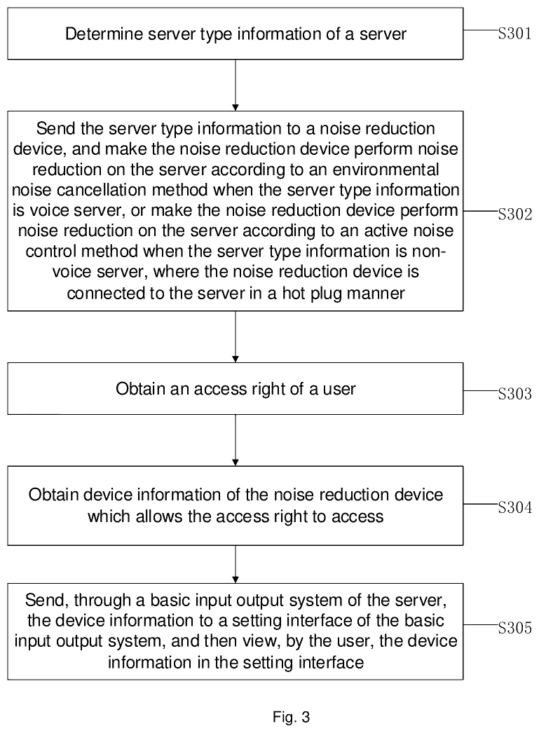

With reference to FIG. 3, FIG. 3 is a third flowchart of a method for reducing server noise according to some embodiments of the present disclosure.

A method for reducing server noise provided in the embodiments of the present disclosure is applied to a server. The method for reducing server noise includes:
S301: server type information of the server is determined.
S302: the server type information is sent to a noise reduction device, and the noise reduction device performs noise reduction on the server according to an environmental noise cancellation method when the server type information is voice server, or the noise reduction device performs noise reduction on the server according to an active noise control method when the server type information is non-voice server, where the noise reduction device is connected with the server in a hot plug manner.
S303: an access right of a user is obtained.
S304: device information of the noise reduction device which allows the access right to access is obtained.
S305: the device information is sent through a basic input output system of the server to a setting interface of the basic input output system, and then the user views the device information in the setting interface.

In practical application, when the noise reduction device is used to perform noise reduction on the server, in order to make the user understand working information of the noise reduction device through the server conveniently, the server may also obtain the access right of the user; obtain the device information of the noise reduction device which allows the access right to access, and send, through the basic input output system (BIOS) of the server, the device information to the setting interface of the basic input output system, such that the user views the device information in the setting interface. Thus the user can view the device information of the noise reduction device in the setting interface of the basic input output system.

It should be noted that a data size of the device information of the noise reduction device that can be viewed in the setting interface of the basic input output system is determined according to a size of the setting interface, which is not limited herein.

In a practical application scenario, in order to facilitate control over the noise reduction device through the server by the user, after sending the device information to the setting interface of the basic input output system through the basic input output system of the server, the server further receive, through the basic input output system, a second regulation instruction transmitted by the setting interface, and send the second regulation instruction to the noise reduction device, to make the noise reduction device perform work control according to the second regulation instruction. Reference is made to the first regulation instruction for a content of the second regulation instruction, which is not repeated herein.

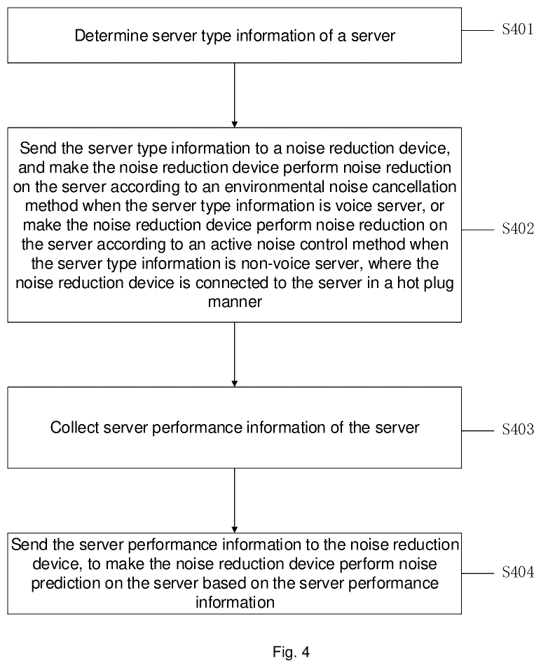

With reference to FIG. 4, FIG. 4 is a fourth flowchart of a method for reducing server noise according to some embodiments of the present disclosure.

A method for reducing server noise provided in some embodiments of the present disclosure is applied to a server. The method includes:
S401: server type information of the server is determined.
S402: the server type information is sent to a noise reduction device, and the noise reduction device performs noise reduction on the server according to an environmental noise cancellation method when the server type information is voice server, or the noise reduction device performs noise reduction on the server according to an active noise control method when the server type information is non-voice server, where the noise reduction device is connected with the server in a hot plug manner.
S403: server performance information of the server is collected.
S404: the server performance information is sent to the noise reduction device, to make the noise reduction device perform noise prediction on the server based on the server performance information.

In practical application, in order to accurately perform noise reduction on the server by the noise reduction device, the server further collects server performance information of the server; and send the server performance information to the noise reduction device, to make the noise reduction device perform noise prediction on the server based on the server performance information. Thus noise reduction, etc. can be performed on the server based on a noise prediction result.

In a practical application scenario, in a process of collecting the server performance information of the server, the server collects fan speed information of the server; collect a quantity value of central processing units of the server and a first temperature value of each central processing unit; collect a second temperature value of an internal memory of the server; collect a working frequency value of a radiator of the server; and take the fan speed information, the quantity value, the first temperature value, the second temperature value, and the working frequency value as the server performance information.

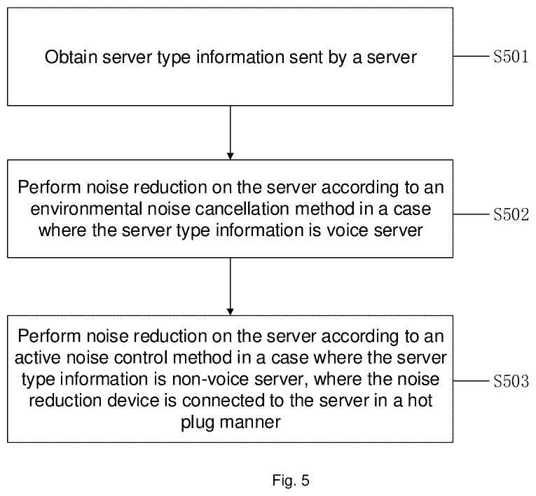

With reference to FIG. 5, FIG. 5 is a fifth flowchart of a method for reducing server noise according to some embodiments of the present disclosure.

A method for reducing server noise provided in some embodiments of the present disclosure is applied to a noise reduction device. The method includes:
S501: server type information sent by a server is obtained.
S502: noise reduction is performed on the server according to an environmental noise cancellation method in a case where the server type information is voice server.
S503: noise reduction is performed on the server according to an active noise control method in a case where the server type information is non-voice server, where the noise reduction device is connected with the server in a hot plug manner.

some embodiments of the present disclosure provide a method for reducing server noise, applied to a server. The server type information sent by the server is obtained. Noise reduction is performed on the server according to the environmental noise cancellation method in a case where the server type information is voice server. Noise reduction is performed on the server according to the active noise control method in a case where the server type information is non-voice server. The noise reduction device is connected with the server in a hot plug manner. The present disclosure has the following beneficial effects: the server sends the server type information of the server to the noise reduction device. Then the noise reduction device performs noise reduction on the server according to the environmental noise cancellation method when the server type information is voice server, or performs noise reduction on the server according to the active noise control method when the server type information is non-voice server. A noise reduction method adapted to the server is flexibly selected for noise reduction, and noise reduction accuracy is desirable. The noise reduction device is connected with the server in a hot plug manner. Thus when noise reduction is required for the server, the noise reduction device needs to be connected with the server. no noise reduction is required for the server, the noise reduction device may be separated from the server, and noise reduction management can be quickly performed on the server.

In practical application, in order to accurately perform noise reduction on the server, the noise reduction device further obtains server performance information sent by the server; perform data cleaning and selection on the server performance information to obtain target performance information; send the target performance information to a prediction model pre-trained based on an extreme gradient boosting (XGBoost) algorithm; and receive a noise value of the server output by the prediction model. In a prediction model training process, a known noise value and corresponding known performance information of the server is collected. The prediction model may be trained by using the known noise value and the known performance information. A corresponding loss value is calculated. Training of the prediction model is ended after the loss value satisfies a set requirement. Otherwise the known noise value and the known performance information is reapplied to perform a new round of training on the prediction model.

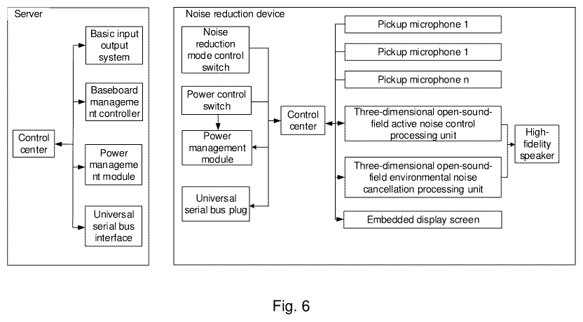

With reference to FIG. 6, FIG. 6 is a schematic structural diagram of a system for reducing server noise according to some embodiments of the present disclosure.

The system for reducing server noise provided in some embodiments of the present disclosure includes a server and a noise reduction device that are connected in a hot plug manner.

The server is configured to determine server type information and send the server type information to the noise reduction device.

The noise reduction device is configured to perform noise reduction on the server according to an environmental noise cancellation method when the server type information is voice server, or perform noise reduction on the server according to an active noise control method when the server type information is non-voice server.

The system for reducing server noise provided in the present disclosure includes a server and a noise reduction device that are connected in a hot plug manner. The server is configured to determine server type information and send the server type information to the noise reduction device. The noise reduction device is configured to perform noise reduction on the server according to an environmental noise cancellation method when the server type information is voice server, or perform noise reduction on the server according to an active noise control method when the server type information is non-voice server. The present disclosure has the following beneficial effects: the server sends the server type information of the server to the noise reduction device. Then the noise reduction device performs noise reduction on the server according to the environmental noise cancellation method when the server type information is voice server, or performs noise reduction on the server according to the active noise control method when the server type information is non-voice server. A noise reduction method adapted to the server is flexibly selected for noise reduction, and noise reduction accuracy is desirable. The noise reduction device is connected to the server in a hot plug manner. Thus when noise reduction is required for the server, the noise reduction device needs to be connected to the server. When no noise reduction is required for the server, the noise reduction device is separated from the server, and noise reduction management can be quickly performed on the server.

In practical application, the server is provided with a universal serial bus (USB) interface supporting hot plug and having uniform standards. Correspondingly, the noise reduction device is provided with a universal serial bus plug matching the universal serial bus interface. That is, the server and the noise reduction device is connected through a USB interface supporting hot plug.

It should be noted that the noise reduction device is provided with a noise reduction mode control switch and a power control switch. The user can directly control the noise reduction mode control switch or the power control switch of the noise reduction device to control a noise reduction mode or switch of the noise reduction device. Furthermore, the noise reduction device can also be provided with an embedded display screen. A predicted noise value, an actual noise value, a noise reduction value, a received fan speed of the server, and other relevant information can be dynamically displayed on the embedded display screen. Thus the user can better obtain information feedback and experience a noise reduction effect better in hearing and vision.

In practical application, the server further is configured to: obtain an access right of a user; obtain device information of the noise reduction device which allows the access right to access; and send, through a baseboard management controller of the server, the device information to a network interface of the baseboard management controller, and then view, by the user, the device information in the network interface.

In practical application, the server is further configured to: receive, through the baseboard management controller, a first regulation instruction transmitted by the network interface after the device information is sent to the network interface of the baseboard management controller through the baseboard management controller of the server; and send the first regulation instruction to the noise reduction device, to make the noise reduction device perform work control according to the first regulation instruction.

In practical application, the server is further configured to: obtain a login request for accessing in to the network interface of the baseboard management controller before obtaining the access right of the user; in respond to the login request, and displaying the network interface; obtain login information input by the user in the network interface; and verify the login information, and perform, in a case of a verification success, the step that the access right of the user is obtained.

In practical application, the server is further configured to: obtain an access right of a user; obtain device information of the noise reduction device which allows the access right to access; and send, through a basic input output system of the server, the device information to a setting interface of the basic input output system, and then view, by the user, the device information in the setting interface.

In practical application, the server is further configured to: receive, through the basic input output system, a second regulation instruction transmitted by the setting interface after sending the device information to the setting interface of the basic input output system through the basic input output system of the server; and send the second regulation instruction to the noise reduction device, to make the noise reduction device perform work control according to the second regulation instruction.

In practical application, the server is further configured to: collect server performance information of the server; and send the server performance information to the noise reduction device, to make the noise reduction device perform noise prediction on the server based on the server performance information. Correspondingly, the noise reduction device is further configured to: obtain server performance information sent by the server; perform data cleaning and selection on the server performance information to obtain target performance information; send the target performance information to a prediction model pre-trained based on an XGBoost algorithm; and receive a noise value of the server output by the prediction model.

In practical application, in a process of collecting the server performance information of the server, the server may collect fan speed information of the server; collect a quantity value of central processing units of the server and a first temperature value of each central processing unit; collect a second temperature value of an internal memory of the server; collect a working frequency value of a radiator of the server; and take the fan speed information, the quantity value, the first temperature value, the second temperature value, and the working frequency value as the server performance information.

In a practical application scenario, the noise reduction device is combined with three-dimensional open-sound-field active noise reduction to reduce noise. Since three-dimensional open-sound-field active noise reduction requires two or more pickup microphones, the pickup microphones are configured to collect noise signals of the server and convert them into electrical signals, which are transmitted to the control center of the noise reduction device through a circuit. The noise reduction device then processes the noise signals according to a currently selected noise reduction mode and an indoor three-dimensional sound source positioning optimization algorithm.

For ease of understanding, assuming that the noise reduction device currently selects an active noise control mode, the signals are processed by a three-dimensional open-sound-field active noise control processing unit. Through the indoor three-dimensional sound source positioning optimization algorithm, an adaptive filtering algorithm and a least mean square (LMS) algorithm, and in combination with a current noise reduction hardware device, such as a distance between a microphone and a speaker and microphone sensitivity, the anti-noise signal for noise reduction is calculated. The calculated anti-noise signal is output with fidelity through a high-fidelity (Hi-Fi) speaker. A sound wave with a same amplitude but an opposite phase (also called anti-phase) to original noise of the server is emitted. The anti-phase sound wave is superimposed with the noise of the server, thus a result of global noise reduction is achieved.

For ease of understanding, assuming that the noise reduction device currently selects an environmental noise cancellation mode, the signals are processed by a three-dimensional open-sound-field environmental noise cancellation processing unit. In this process, besides the indoor three-dimensional sound source positioning optimization algorithm, the adaptive filtering algorithm and the LMS algorithm, processing also relies on an artificial intelligence (AI) neural network noise reduction algorithm, gain control, echo cancellation, and a beam forming technology algorithm in a multi-microphone situation. Before calculation of an environmental noise filtering module, in order to guarantee the noise reduction effect, a gain of a microphone array and a delay of microphones are corrected first. Whether data collected by a voice microphone are a voice segment is detected. If yes, environmental noise is estimated according to environmental noise collected by a reference microphone and voice data collected by the voice microphone, a corresponding noise suppression parameter is calculated, and environmental noise is filtered out by a filter module. If no, no environmental noise filtering is performed. Accordingly, the corresponding anti-noise signal is calculated, and then the calculated anti-noise signal is output with fidelity through the Hi-Fi speaker to emit the sound wave with the same amplitude but the opposite phase (also called anti-phase) to the original sound. The anti-phase sound wave is superimposed with the noise, thus the result of global noise reduction is achieved.

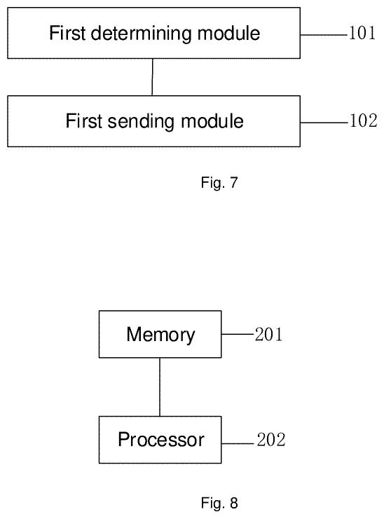

With reference to FIG. 7, FIG. 7 is a schematic structural diagram of an apparatus for reducing server noise according to some embodiments of the present disclosure.

An apparatus for reducing server noise provided in some embodiments of the present disclosure is applied to a server. The apparatus includes:
a first determining module 101 configured to determine server type information of the server; and
a first sending module 102 configured to send the server type information to a noise reduction device, and make the noise reduction device perform noise reduction on the server according to an environmental noise cancellation method when the server type information is voice server, or make the noise reduction device perform noise reduction on the server according to an active noise control method when the server type information is non-voice server, where
the noise reduction device is connected with the server in a hot plug manner.

An apparatus for reducing server noise provided in some embodiments of the present disclosure is applied to a server. The apparatus further includes:
a first obtaining module configured to obtain an access right of a user;
a second obtaining module configured to obtain device information of the noise reduction device which allows to the access right access; and
a second sending module configured to send, through a baseboard management controller of the server, the device information to a network interface of the baseboard management controller, and then view, by the user, the device information in the network interface.

An apparatus for reducing server noise provided in some embodiments of the present disclosure is applied to a server. The apparatus further includes:
a first receiving module configured to receive, through the baseboard management controller, a first regulation instruction transmitted by the network interface after the device information is sent by the second sending module to the network interface of the baseboard management controller through the baseboard management controller of the server; and
a third sending module configured to send the first regulation instruction to the noise reduction device, to make the noise reduction device perform work control according to the first regulation instruction.

An apparatus for reducing server noise provided in the example of the present disclosure is applied to a server. The apparatus further includes:
a first verifying module configured to: obtain a login request for accessing in to the network interface of the baseboard management controller before the first obtaining module obtains the access right of the user; in response to the login request, and displaying the network interface; obtain login information input by the user in the network interface; and verify the login information, and perform, in a case of a verification success, the step that the access right of the user is obtained.

An apparatus for reducing server noise provided in some embodiments of the present disclosure is applied to a server. The apparatus further includes:
a third obtaining module configured to obtain an access right of a user;
a fourth obtaining module configured to obtain device information of the noise reduction device which allows the access right to access; and
a fourth sending module configured to send, through a basic input output system of the server, the device information to a setting interface of the basic input output system, and then view, by the user, the device information in the setting interface.

An apparatus for reducing server noise provided in some embodiments of the present disclosure is applied to a server. The apparatus further includes:
a second receiving module configured to receive, through the basic input output system, a second regulation instruction transmitted by the setting interface after the fourth sending module sends, through the basic input output system of the server, the device information to the setting interface of the basic input output system; and
a fifth sending module configured to send the second regulation instruction to the noise reduction device, to make the noise reduction device perform work control according to the second regulation instruction.

An apparatus for reducing server noise provided in some embodiments of the present disclosure is applied to a server. The apparatus further includes:
a first collecting module configured to collect server performance information of the server; and
a sixth sending module configured to send the server performance information to the noise reduction device, to make the noise reduction device perform noise prediction on the server based on the server performance information.

An apparatus for reducing server noise provided in some embodiments of the present disclosure is applied to a server. The first collecting module includes:
a first collecting unit configured to collect fan speed information of the server;
a second collecting unit configured to collect a quantity value of central processing units of the server and a first temperature value of each central processing unit;
a third collecting unit configured to collect a second temperature value of an internal memory of the server;
a fourth collecting unit configured to collect a working frequency value of a radiator of the server; and
a first setting unit configured to take the fan speed information, the quantity value, the first temperature value, the second temperature value, and the working frequency value as the server performance information.

An apparatus for reducing server noise provided in some embodiments of the present disclosure is applied to a noise reduction device. The apparatus includes:
a fifth obtaining module configured to obtain server type information sent by a server;
a first noise reducing module configured to perform noise reduction on the server according to an environmental noise cancellation method in a case where the server type information is voice server; and
a second noise reducing module configured to perform noise reduction on the server according to an active noise control method in a case where the server type information is non-voice server.

The noise reduction device is connected with the server in a hot plug manner.

An apparatus for reducing server noise provided in some embodiments of the present disclosure is applied to a noise reduction device. The apparatus further includes:
a sixth obtaining module configured to obtain server performance information sent by the server;
a first processing module configured to perform data cleaning and selection on the server performance information to obtain target performance information; and
a first predicting module configured to: send the target performance information to a prediction model pre-trained based on an XGBoost algorithm; and receive a noise value of the server output by the prediction model.

some embodiments of the present disclosure further provide an electronic device and a computer nonvolatile readable storage medium, both of which have corresponding effects of the method for reducing server noise provided in some embodiments of the present disclosure. With reference FIG. 8, FIG. 8 is a schematic structural diagram of an electronic device according to some embodiments of the present disclosure.

A fan speed processing device provided in some embodiments of the present disclosure includes a memory 201 and a processor 202. A computer program is stored in the memory 201. The processor 202 implements steps of the method for reducing server noise described in any one of the above embodiments when executing the computer program.

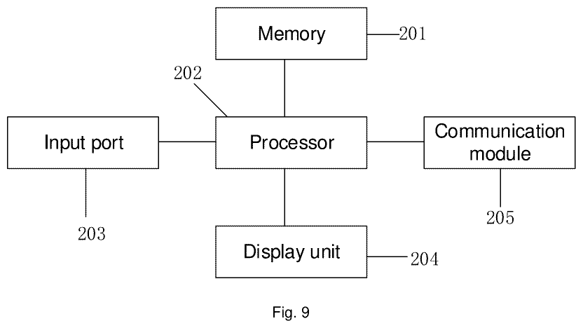

With reference to FIG. 9, another electronic device provided in some embodiments of the present disclosure further includes an input port 203 connected with the processor 202 and configured to transmit a command input from the outside to the processor 202, a display unit 204 connected with the processor 202 and configured to display a processing result of the processor 202 to the outside, and a communication module 205 connected with the processor 202 and configured to implement communication between the electronic device and the outside. The display unit 204 is a display panel, a laser scanning display, etc. A communication manner used by the communication module 205 includes, but is not limited to, mobile high-definition link (MHL) technology, a universal serial bus (USB), a high-definition multimedia interface (HDMI), wireless connection: wireless fidelity (WiFi) technology, Bluetooth communication technology, Bluetooth low energy communication technology, and IEEE802.11s-based communication technology.

A computer nonvolatile readable storage medium provided in some embodiments of the present disclosure stores a computer program. The computer program implements steps of the method for reducing server noise according to any one of the above embodiments when executed by a processor.

The computer nonvolatile readable storage medium related to the present disclosure includes a random access memory (RAM), an internal memory, a read-only memory (ROM), an electrically programmable ROM, an electrically erasable programmable ROM, a register, a hard disk, a removable magnetic disk, a compact disc read-only memory (CD-ROM), or any other form of storage nonvolatile readable storage medium known in the technical field.

Reference is made to detailed description of corresponding parts in the method for reducing server noise provided in some embodiments of the present disclosure for description of relevant parts in the system for reducing server noise, the electronic device and the computer nonvolatile readable storage medium provided in the examples of the present disclosure, which will not be repeated herein. Furthermore, in the above technical solution provided in the embodiments of the present disclosure, a part consistent with an implementation principle of a corresponding technical solution in the art known to inventors is not described in detail, so as to avoid excessive repetition.

It should be further noted that in the specification, relational terms such as first and second are merely used to distinguish one entity or one operation from another entity or another operation, and do not necessarily require or imply any such actual relationship or order among these entities or operations. Moreover, the terms “comprise”, “include”, or their any other variations are intended to cover non-exclusive inclusions. Thus a process, method, article, or device including a series of elements not includes those elements, but also includes other elements that are not explicitly listed, or further includes inherent elements of such a process, method, article, or device. Without more restrictions, the elements defined by the sentence “comprise a . . . ” or “include a . . . ” do not exclude the existence of other identical elements in the process, method, article, or device including the elements.

The foregoing description of the disclosed examples enables those skilled in the art to make or use the present disclosure. Various modifications to these examples will be apparent to those skilled in the art, and the general principles defined herein can be implemented in other examples without departing from the spirit or scope of the present disclosure. Thus, the present disclosure is to accord with the widest scope consistent with the principles and novel features disclosed herein instead of being limited to the examples described herein.

1. A method for reducing server noise, applied to a server, comprising:
determining server type information of the server; and
sending the server type information to a noise reduction device, and making the noise reduction device perform noise reduction on the server according to an environmental noise cancellation method in a case where the server type information is voice server, or making the noise reduction device perform noise reduction on the server according to an active noise control method in a case where the server type information is non-voice server, wherein
the noise reduction device is connected with the server in a hot plug manner.

2. The method for reducing server noise as claimed in claim 1, wherein the method for reducing server noise also comprises:
obtaining an access right of a user;
obtaining device information of the noise reduction device which allowed the access right to access; and
sending, through a baseboard management controller of the server, the device information to a network interface of the baseboard management controller, and then viewing, by the user, the device information in the network interface.

3. The method for reducing server noise as claimed in claim 2, wherein after the sending, through a baseboard management controller of the server, the device information to a network interface of the baseboard management controller, the method for reducing server noise also comprises:
receiving, through the baseboard management controller, a first regulation instruction transmitted by the network interface; and
sending the first regulation instruction to the noise reduction device, to make the noise reduction device perform work control according to the first regulation instruction.

4. The method for reducing server noise as claimed in claim 2, wherein before the obtaining an access right of a user, the method for reducing server noise also comprises:
obtaining a login request for accessing in to the network interface of the baseboard management controller;
in response to the login request, and displaying the network interface;
obtaining login information input by the user in the network interface; and
verifying the login information, and performing, in a case of a verification success, the obtaining an access right of a user.

5. The method for reducing server noise as claimed in claim 1, wherein the method for reducing server noise also comprises comprising:
obtaining an access right of a user;
obtaining device information of the noise reduction device which allows the access right to access; and
sending, through a basic input output system of the server, the device information to a setting interface of the basic input output system, and then viewing, by the user, the device information in the setting interface.

6. The method for reducing server noise as claimed in claim 5, wherein after the sending, through a basic input output system of the server, the device information to a setting interface of the basic input output system, the method for reducing server noise also comprises:
receiving, through the basic input output system, a second regulation instruction transmitted by the setting interface; and
sending the second regulation instruction to the noise reduction device, to make the noise reduction device perform work control according to the second regulation instruction.

7. The method for reducing server noise as claimed in claim 1, wherein the method for reducing server noise comprises:
collecting server performance information of the server; and
sending the server performance information to the noise reduction device, to make the noise reduction device perform noise prediction on the server based on the server performance information.

8. The method for reducing server noise as claimed in claim 7, wherein the collecting server performance information of the server comprises:
collecting fan speed information of the server;
collecting a quantity value of central processing units of the server and a first temperature value of each central processing unit;
collecting a second temperature value of an internal memory of the server;
collecting a working frequency value of a radiator of the server; and
taking a fan speed information, a quantity value, a first temperature value, a second temperature value, and a working frequency value as the server performance information.

9. A method for reducing server noise, applied to a noise reduction device, comprising:
obtaining server type information sent by a server;
performing noise reduction on the server according to an environmental noise cancellation method in a case where the server type information is voice server; and
performing noise reduction on the server according to an active noise control method in a case where the server type information is non-voice server, wherein
the noise reduction device is connected with the server in a hot plug manner.

10. The method for reducing server noise as claimed in claim 9, wherein the method for reducing server noise also comprises:
obtaining server performance information sent by the server;
performing data cleaning and selection on the server performance information to obtain target performance information;
sending the target performance information to a prediction model pre-trained based on an extreme gradient boosting (XGBoost) algorithm; and
receiving a noise value of the server output by the prediction model.

11. The method for reducing server noise as claimed in claim 10, wherein before the obtaining server performance information sent by the server, wherein the method for reducing server noise comprises:
collecting a known noise value and corresponding known performance information of the server;
training the prediction model by using the known noise value and the known performance information, and calculating a corresponding loss value; and
ending training of the prediction model after a loss value satisfies a set requirement, and otherwise reapplying the known noise value and the known performance information to perform a new round of training on the prediction model.

12. The method for reducing server noise as claimed in claim 9, wherein the performing noise reduction on the server according to an active noise control method comprises:
processing a noise signal by a three-dimensional open-sound-field active noise control processing unit.

13. The method for reducing server noise as claimed in claim 12, wherein the processing a noise signal by a three-dimensional open-sound-field active noise control processing unit comprises:
calculating an anti-noise signal for noise reduction by the three-dimensional open-sound-field active noise control processing unit through an indoor three-dimensional sound source positioning optimization algorithm, an adaptive filtering algorithm, a least mean square algorithm and a current noise reduction hardware device; and
outputting the anti-noise signal with fidelity by the three-dimensional open-sound-field active noise control processing unit through a high-fidelity speaker to emit an anti-phase sound wave, wherein the anti-phase sound wave is a sound wave having a same amplitude but an opposite phase to the noise signal, and the anti-phase sound wave is used for being superimposed with the noise signal.

14. The method for reducing server noise as claimed in claim 9, wherein the performing noise reduction on the server according to an environmental noise cancellation method comprises:
processing a noise signal by a three-dimensional open-sound-field environmental noise cancellation processing unit.

15. The method for reducing server noise as claimed in claim 14, wherein before the processing a noise signal by a three-dimensional open-sound-field environmental noise cancellation processing unit, the method for reducing server noise comprises:
correcting a gain of a microphone array and a delay of microphones;
detecting whether data collected by a voice microphone are a voice segment;
estimating environmental noise according to environmental noise collected by a reference microphone and voice data collected by the voice microphone in a case of detecting that the data collected by the voice microphone are a voice segment, calculating a corresponding noise suppression parameter, and filtering environmental noise out by a filter module; and performing no environmental noise filtering in a case of detecting that the data collected by the voice microphone are not a voice segment.

16. A system for reducing server noise, comprising a server and a noise reduction device that are connected in a hot plug manner, wherein
the server is used for determining server type information and sending the server type information to the noise reduction device; and
the noise reduction device is used for performing noise reduction on the server according to an environmental noise cancellation method in a case where the server type information is voice server, or performing noise reduction on the server according to an active noise control method in a case where the server type information is non-voice server.

17. The system for reducing server noise as claimed in claim 16, wherein the server is provided with a universal serial bus interface supporting hot plug and having uniform standards; and
the noise reduction device is provided with a universal serial bus plug matching the universal serial bus interface.

18. (canceled)

19. An electronic device, comprising:
a memory configured to store a computer program; and
a processor configured to implement steps of the method for reducing server noise as claimed in in a case of executing the computer program.

20. A computer nonvolatile readable storage medium, storing a computer program, wherein the computer program implements steps of the method for reducing server noise as claimed in in a case of executed by a processor.

21. The system for reducing server noise as claimed in claim 16, wherein the noise reduction device is provided with a noise reduction mode control switch and a power control switch, the user directly controls the noise reduction mode control switch or the power control switch of the noise reduction device to control a noise reduction mode or switch of the noise reduction device.
